(19) United States
(12) Patent Application Publication
(10) Pub. No.: US 2017/0309372 A1
(43) Pub. Date: Oct. 26, 2017

(54) RINGED TUBULAR SHEATH HAVING A DETACHABLE LONGITUDINAL STRIP

(71) Applicant: DELFINGEN FR-ANTEUIL S.A., Anteuil (FR)

(72) Inventors: Dalille Zaidi, Montbéliard (FR); Patrick Loison, Noisy sur Ecole (FR); Matthieu BERNICOT, Baume-les-Dames (FR)

(73) Assignee: DELFINGEN FR-ANTEUIL S.A., Anteuil (FR)

(21) Appl. No.: 15/503,391

(22) Filed: Feb. 11, 2017

(30) Foreign Application Priority Data
Aug. 13, 2014 (FR) 14/01847

(51) Int. Cl. H01B 7/17; B29C 47/06; B29C 47/00; B29K 77/00; B29L 23/18

(52) U.S. Cl. CPC H01B 7/17; B29C 47/06; B29C 47/0038; B29L 2023/18; B29K 2077/00

(57) ABSTRACT

The invention relates to a ringed tubular sheath which comprises a longitudinal strip which can be easily detached by a user, in particular manually. More specifically, the invention relates to a ringed tubular sheath comprising a sheath body (1) and a longitudinal strip (6) which are made of materials that substantially do not adhere to one another, the longitudinal strip (6) comprising, on each of its longitudinal sides, an upper projection (2, 8) and a lower projection (3, 9), between which a respective longitudinal edge (5, 7) of the sheath body (1) is fitted, this sheath being distinctive in that the longitudinal strip (6) is substantially in the shape of an arc of a ringed tube. The invention also relates to a manufacturing method and to the use of such a sheath.

The invention relates to a ringed tubular sheath which comprises a longitudinal strip which can be easily detached by a user, in particular manually. The invention also relates to a manufacturing method and to the use of such a sheath.

### BACKGROUND OF THE INVENTION

For a long time ringed tubular sheaths have been used to protect wires and/or cables, particularly in the automobile industry.

The international application published under number WO 02/087048 concerns a ringed tubular sheath comprising a longitudinal strip in flexible material. In particular, the second embodiment of this sheath, illustrated by FIGS. 4 and 5 of this international application, provides for the making of a longitudinal cut in a longitudinal strip in flexible material whose width is limited in order not to modify the characteristics of the original product. The cut is designed to produce a slot enabling the installation of the wires or cables inside the sheath.

The German patent application published under number DE 10 2004 005 307 concerns a means of closing for longitudinally slotted tubular sheaths, particularly ringed tubular sheaths designed to protect electrical cables in vehicles. This means of closing is produced in the form of a double T. As can be seen in particular in FIG. 4 of this document, it may comprise alternating upper ridges 12 and lower ridges 13 attached on a longitudinal central bar 14.

The German patent application published under number DE 10 2006 062 544 concerns a device for the manufacturing of longitudinally slotted ringed cable protection tubes, comprising a spool supplying closing element to close the slot. This closing element is shown as item 4 in FIG. 4, in which it can be seen that it is rail-shaped.

International application no. WO 2013/065352 concerns an element for maintaining the shape of a slotted ringed tube presenting a groove for each longitudinal edge of the tube. The upper parts of the grooves can be corrugated to penetrate partially into the spaces between the rings.

The European patent application published under number EP 223 424 relates to a closing element for a longitudinally slotted circular sheath. This sheath is not however ringed and the longitudinal edges of the slot are each extended by a rail-shaped upper part forming a groove extending longitudinally. A discontinuous closing channel is provided to hold the sheath closed and a closing element produced in the form of a clip can thus insert its two longitudinal ends in the grooves and in the gap in the closing channel.

Japanese patent application no. JP 2006 320181 proposes an auxiliary component designed to be inserted in the slot of a slotted tube to protect the electrical wires contained in the tube and prevent the movement of the tube in a longitudinal direction by means of blocking walls located at its longitudinal ends.

All the solutions proposed in the above five documents lead in particular to stiffening of the tube or the sheath.

### Concise Presentation of the Invention

The main aim of the invention is to propose a ringed tubular sheath whose opening is facilitated and can be done at a stage subsequent to the manufacturing of the sheath, particularly at the place of use of the sheath.

According to the invention, the aim is achieved by means of a ringed tubular sheath comprising a sheath body and a longitudinal strip and in which the sheath body and the strip are made of materials that substantially do not adhere to one another, the longitudinal strip comprising, on each of its longitudinal sides, an upper projection and a lower projection between which a respective longitudinal edge of the sheath is fitted, this sheath being distinctive in that the longitudinal strip is substantially in the shape of an arc of a ringed tube.

Thanks to this feature, the ringed tubular sheath according to the invention can retain all its flexibility despite the presence of the longitudinal strip.

Other features and advantages of the invention will now be described in detail presentation which follows which is given with reference to the appended figures, which show schematically:

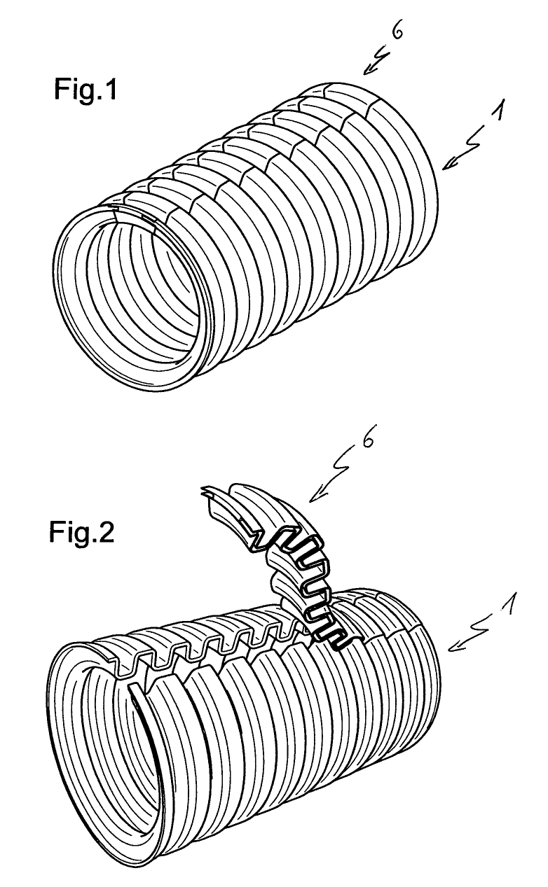

FIG. 1: a ringed tubular sheath according to the invention in perspective, before detachment of the longitudinal strip;

FIG. 2: the ringed tubular sheath in FIG. 1, after partial detachment of the longitudinal strip;

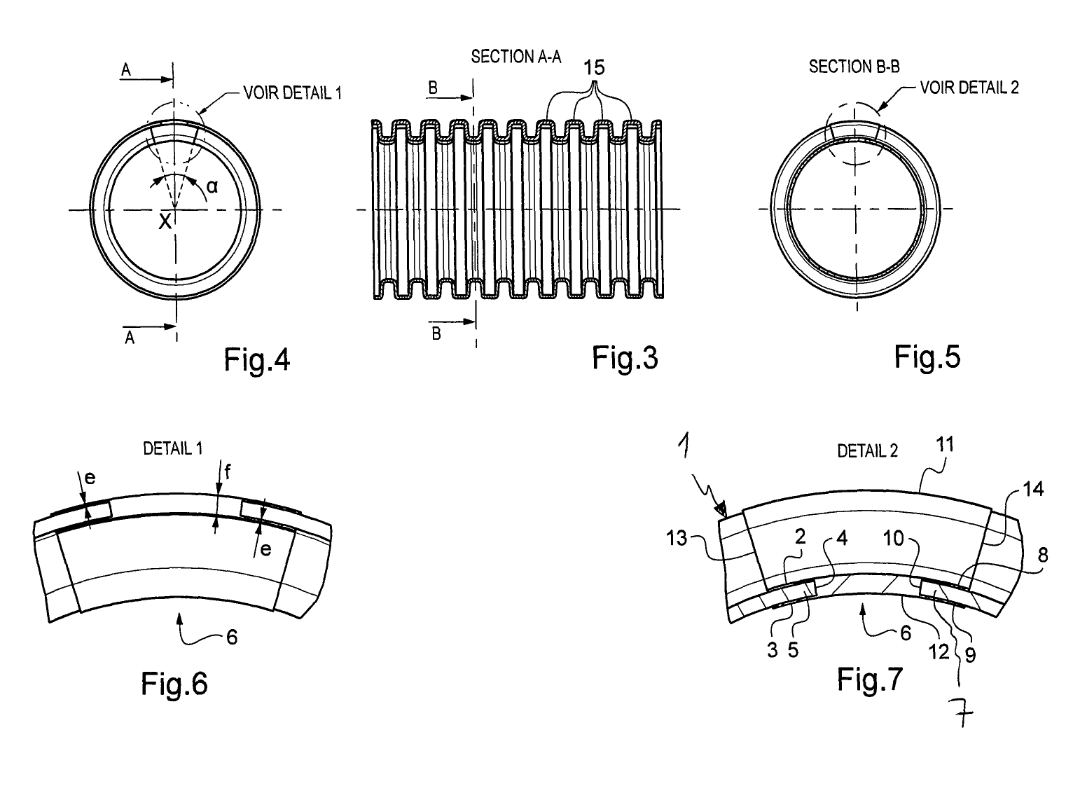

FIG. 3: a ringed tubular sheath according to the invention in longitudinal section along A-A;

FIG. 4: the ringed tubular sheath in FIG. 3, viewed from the right;

FIG. 5: the ringed tubular sheath in FIG. 3, viewed from the left in section along

B-B;

FIG. 6: a detail of FIG. 4;

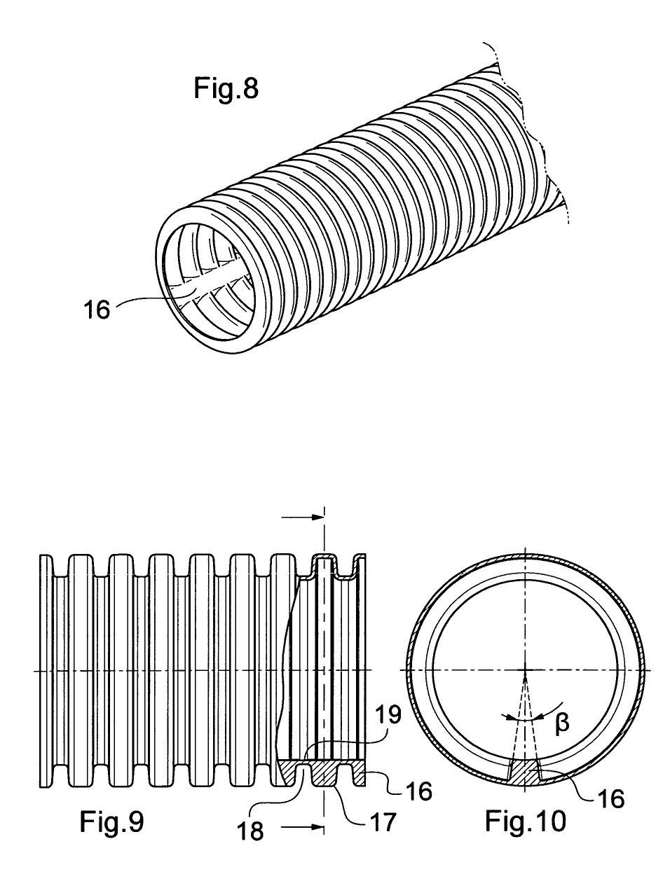

FIG. 7: a detail of FIG. 5;

FIG. 8: a ringed tubular sheath according to an advantageous embodiment of the invention, in perspective;

FIG. 9: a longitudinal partial section of the sheath in FIG. 8; and

FIG. 10: a cross section of the sheath in FIG. 8.

### CONCISE PRESENTATION OF THE INVENTION

An embodiment of a ringed tubular sheath according to the invention is shown in FIGS. 1 to 4.

As can be seen in FIG. 1, the ringed tubular sheath according to the invention resembles a conventional ringed tubular sheath. It generally has a longitudinal sheath body 1 and a longitudinal strip 6.

According to the invention, the sheath body consists of a first material and the longitudinal strip of a second material.

The first and second materials do not substantially adhere to one another, so that the two parts of the sheath can be easily separated, particularly by hand, by a user. To do this, the user simply has to grasp an axial end of the strip, for example between the thumb and forefinger of one hand, and hold the sheath with the other hand, and then pull the light strip to tear it off the sheath, in order to obtain the situation which can be seen in FIG. 2, where we see a longitudinal strip 6 partially detached longitudinally from the sheath body 1.

For the separation of the longitudinal strip to be possible, it is necessary to provide mechanical support for this strip on the sheath body which is simultaneously sufficient for normal handling, transport and installation of the sheath but not too stiff to ensure that detachment is possible, particularly manually, without having to use too much force.

According to the invention, such a result is obtained by providing for the longitudinal strip to have, on each of its longitudinal sides, an upper projection and a lower projection between which the respective longitudinal edge of the sleeve is accommodated and to some extent pinched.

This characteristic is clearly apparent in FIG. 7, where we see
firstly, a left longitudinal edge 5 of the sheath body 1 partially surrounded by a left upper projection 2, a left lower projection 3 and a left bottom 4 of the longitudinal strip 6, these last three elements forming a left groove accommodating the left longitudinal edge 5, and
secondly, a right longitudinal edge 7 of the sheath body 1 partially surrounded by a right upper projection 8, a right lower projection 9 and a right bottom 10 of the longitudinal strip 6, these last three elements forming a right groove accommodating the right longitudinal edge 7.

According to the invention, the longitudinal strip 6 substantially takes the shape of an arc of a ringed tube. The central part of the longitudinal strip 6, i.e. the longitudinal strip 6 without its projections 2, 3, 8 and 9, is perfectly akin to a piece of ringed tubular sheath and its shape is, or corresponds to, that of an arc of a ringed tube.

In other words, the longitudinal strip 6 is formed by an arc of a circle in cross section, which develops longitudinally parallel to the longitudinal axis of the sheath and in a serrated way, closely fitting the shape of the rings of the sheath body 1 so as to completely extend the sheath, which then appears to be complete, without a longitudinal slot.

Thus, as show in FIGS. 4 to 7, the longitudinal strip 6 completes the sheath body 1, serving as a junction between the left and right longitudinal edges 5 and 7 of the sheath body 1.

As can be seen in FIG. 3, the longitudinal strip 6 is serrated, its serrations 15 corresponding to the rings of the sheath body 1 and extending them. Thus, the longitudinal strip 6 does not obstruct the hollows, i.e. the spaces between the rings, unlike what happens with the solutions proposed in the prior art, and, thanks to this, it allows the ringed tubular sheath to retain all its flexibility.

In addition, it is preferable for the outer and innerfaces 11 and 12 of the longitudinal strip 6 to be curved like the sheath body 1, so that it appears to be complete, that is to say, completely closed (except obviously at its axial ends), as can be seen in particular in FIG. 1.

As regards the respective proportions of the sheath body 1 and the longitudinal strip 6, they can be defined, when the sheath body 1 is circular, by the angle α formed by the straight lines connecting, in cross section (FIG. 4), the left and right side ends 13 and 14 at the centre of the sheath body 1 represented by point X corresponding to the projection of the longitudinal axis X of the sheath in the plane of the cross section.

This angle α is generally between 5 and 150 degrees and preferably either between 80 and 150 degrees or between 5 and 30 degrees.

According to an advantageous embodiment, the width of the longitudinal strip 6 is varied, i.e. the angle α varies along the longitudinal axis X of the sheath. It can thus increase or decrease steadily along the longitudinal axis X, or undergo any other axial variation.

As regards the dimensions of the projection 2, 3, 8 and 9 of the longitudinal strip 6 on the sheath body 1, they depend in particular on the required longitudinal strip pull-off force and the materials used. They can be defined by the depths of the grooves formed by the upper and lower projections 2, 8 and 3, 9 of the longitudinal strip 6, in which grooves the longitudinal edges 5 and 7 of the sheath body 1 penetrate, generally being in contact with the respective bottoms 4, 10 of these grooves.

These depths generally represent between 10 and 50% and preferably between 20 and 30% of the width of the longitudinal strip 6.

The thicknesses e of the projections generally represent between 5 and 30% and preferably between 10 and 15% of the thickness f of the longitudinal strip 6.

As regards the materials used, the sheath body 1 is generally made from a polyamide. Preferably polyamide 6 is used.

According to the invention, the material of which the longitudinal strip 6 is made should not adhere (or adhere as little as possible) to the material of the sheath body. A polyolefin such as polypropylene or polyethylene is therefore generally chosen. Preferably, polypropylene is used.

Naturally, any other combination of appropriate materials may be suitable, provided that the material of the strip does not adhere (substantially) to the material of the sheath body.

According to a particularly advantageous embodiment of the invention, the sheath is made with a transverse pre-stress exerted against the two longitudinal edges of the strip 6, so that once the strip is withdrawn the sheath closes by itself.

According to another advantageous embodiment of the invention which can be seen in FIGS. 8 to 10, the ringed tubular sheath according to the invention comprises at least one internal longitudinal reinforcement.

As can be seen in particular in FIG. 9, this longitudinal reinforcement may be formed by a filling 16 of the interior space located between the peaks 17 and bases 18 of the rings with thin projections—substantially of the thickness of sheath—creating bridges of material 19 between two adjacent rings.

As can be seen in FIG. 10, the filling 16 extends little perimetrically or circumferentially, so that it can form in cross section, if it is connected to the X-axis, an angle β generally between 5 and 30 degrees and preferably between 10 and 20 degrees.

Manufacturing

The ringed tubular sheath according to the invention can be manufactured in a known manner by co-extrusion of the two aforementioned materials. The person skilled in the art is able to modify a conventional ringed tubular sheath extrusion head to allow the arrival of the second material at the required place. In particular he can draw on the lessons of International Application No. WO 02/078048 and/or prior art cited in the search report concerning this application.

This change being minimal and within the capabilities of any person skilled in the art, the manufacturing can still be considered to be a standard extrusion.

The co-extrusion is followed by three-dimensional forming which is also conventional.

This is particularly interesting because the forming of a sheath which is already open leads to shifting of rings which subsequently poses closing problems. In addition, conventional opening of an already formed sheath requires substantial means (cutting device, etc.).

The sheath according to the invention is therefore obtained closed.

Use

The ringed tubular sheath according to the invention therefore resembles a conventional sheath, as can be seen in FIG. 1. It can therefore be used to protect wires and/or cables in a standard way.

However, according to the invention, it is implemented in an original way. The sheath can be brought closed to its place of use, opened and then installed. Alternatively, it can be brought there closed and then opened and installed simultaneously. Naturally, the sheath can be opened and then brought open to its place of use and subsequently installed.

The opening may in particular be carried out manually by a user, by simply tearing off the longitudinal strip 6, as has been previously described. This has the effect of creating a longitudinal slot through which the user can then slide wires and/or cables, as he would with a conventional slotted ringed tubular sheath.

Thus, thanks to the invention, the opening of the sheath can be carried out by the user at the time of its use.

In addition, it is now possible to produce a sheath which has a longitudinal opening of variable width determined in the design or manufacturing of the sheath.

1. Ringed tubular sheath comprising a sheath body and a longitudinal strip which are made of materials that substantially do not adhere to one another, the longitudinal strip comprising, on each of its longitudinal sides, an upper projection and a lower projection between which a respective longitudinal edge of the sheath body is fitted, characterized in that the longitudinal strip is substantially in the shape of an arc of a ringed tube.

2. Ringed tubular sheath according to claim 1, in which the longitudinal strip completes the sheath body serving as a junction between the longitudinal edges of the sheath body.

3. Ringed tubular sheath according to claim 2, in the longitudinal strip 14 is serrated, its serrations extending the rings of the sheath body.

4. Ringed tubular sheath according to claim 3, wherein in which the longitudinal strip is curved, its radius of curvature being the same as that of the sheath body.

5. Ringed tubular sheath according to claim in which the side ends of the longitudinal strip form with the centre of the sheath an angle (α) between 5 and 150 degrees.

6. Ringed tubular sheath according to claim 4 wherein the side ends of the longitudinal strip form with the centre of the sheath an angle (α) either between 5 and 150 degrees.

7. Ringed tubular sheath according to claim 1, wherein the upper and lower projections create grooves whose depths represent between 10 and 50% of the width of the longitudinal strip.

8. Ringed tubular sheath according to claim 2, wherein the upper and lower projections create grooves whose depths represent between 10% and 50% of the width of the longitudinal strip.

9. Ringed tubular sheath according to claim 3, wherein the upper and lower projections represent between 20 and 30% create grooves whose depths represent between 10% and 50% of the width of the longitudinal strip.

10. Ringed tubular sheath according to claim 5, wherein the upper and lower projections create grooves whose depths represent between 10% and 50% of width of the longitudinal strip.

11. Ringed tubular sheath according to claim 1, wherein the sheath body (1) is in polyamide and the longitudinal strip is in polyolefin.

12. Ringed tubular sheath according to claim 1 made with a transverse pre-stress exerted against the two longitudinal ship (6), so that once the strip is withdrawn the sheath closes automatically.

13. Ringed tubular sheath according to claim 2 made with a transverse pre-stress exerted against the two longitudinal strip, so that once the strip is withdrawn the sheath closes automatically.

14. Ringed tubular sheath according to claim 3 made with a transverse pre-stress exerted against the two longitudinal strip, so that once the ship is withdrawn the sheath closes automatically.

15. Ringed tubular sheath according to claim 1, comprising at least one internal longitudinal reinforcement.

16. Tubular sheath according to claim 3, comprising at least one internal longitudinal reinforcement.

17. Ringed tubular sheath according to claim wherein the internal longitudinal reinforcement is formed by gilling of the interior space located between the peaks and bases of the rings, with projections of material creating bridges between two adjacent rings.

18. Method of manufacturing a ringed tubular sheath according to claim 1, comprising a step of co-extrusion of the material of the sheath body and of the material of the longitudinal strip.

19. Method according to claim 18, wherein the co-extrusion step is followed by a three-dimensional forming step.

20. Method of using a ringed tubular sheath according to claim 1, comprising a step of detaching the longitudinal strip

21. (canceled)
